(19) United States
(12) Patent Application Publication
(10) Pub. No.: US 2007/0023242 A1
(43) Pub. Date: Feb. 1, 2007

(54) Composite brake disk

(75) Inventors: Gerald Krueger, Zell (DE); Oliver Lembach, Winterlingen (DE); Michael Niestegge, Ballendorf (DE)

Correspondence Address: AKERMAN SENTERFITT, P.O. BOX 3188, WEST PALM BEACH, FL, 33402-3188, US

(73) Assignee: DaimlerChrysler AG

(21) Appl. No.: 11/483,004

(22) Filed: Jul. 5, 2006

(30) Foreign Application Priority Data
Jul. 5, 2005 (DE) 10 2005 031291.8

(51) Int. Cl. F16D 65/12

(52) U.S. Cl. 188/218 XL

(57) ABSTRACT

Composite brake disc, comprising cast iron carrier disc (1) and at least one friction ring (2) of the different material rigidly joined therewith, which covers over essentially the area opposite to the brake pad, wherein the friction ring (2) is comprised of a friction material, which exhibits a higher corrosion resistance than the cast iron carrier disc (1), and process for production of a composite brake disc by joining a cast iron carrier disc (1) with at least one friction ring (2) by friction welding or by casting the carrier disc (1) thereon.

### BACKGROUND OF THE APPLICATION

1. Field of the Invention

The invention concerns a composite brake disc, which is comprised of a cast iron carrier disk and at least one further ring of a different material rigidly connected therewith, as well as preferred manufacturing techniques for joining the two components, such as friction welding and compound casting.

2. Description of Related Art

Brake discs are widely employed in motor vehicles. Depending upon braking capacity, conventional brake discs are either formed solidly or are provided with internal ventilation. The brake discs primarily employed in automobiles are almost always comprised entirely of Fe-cast alloys. These include, for example cast iron with lamellar graphite (for example GG 20 or GG25) or with spherical graphite (for example GGG 40, GGG 50 or GGG 60), cast steel for example GS60) or construction steel (for example ST 52-3). Less frequently, aged steels are employed (for example, C45 or 42 CrMo4). The aged steels or, as the case may be, highly alloyed steels, are however significantly more expensive than unhardened or non-highly alloyed steels.

The conventional cast iron materials however exhibit the disadvantage of insufficient corrosion resistance. This is experienced as a negative factor, particularly in the case of winter road salt corrosion.

For improving corrosion resistance, its proposed in DE 197 35 217 B4 and DE 198 57 557 A1 to employ a casting material from the ternary group Fe/Al/C for the brake discs. Due to the high Al-content, the brake disc is comparatively expensive.

One further possibility for corrosion protection is the application of coatings, for example, Zn-coating, as described in EP 0040054 A1.

With coatings, the corrosion can only be partially prevented, since the coating will remain on a friction surface for only a limited amount of time. In operation they are relatively rapidly worn away by the brake linings.

### SUMMARY OF THE INVENTION

It is thus the task of the invention of providing an economic brake disc, which exhibits durable corrosion protection, in particular on the friction surface.

This task is inventively solved by a composite brake disc with a cast iron carrier disk and at least one friction ring of a different material rigidly connected therewith, which covers at least one area facing the brake, as well as processes for producing a composite brake disc by joining a cast carrier disc with at least one friction ring.

The area of the friction ring facing the brake is also referred to in the following as the friction surface.

For the present invention it is of substantial importance that the brake disk is comprised of two different materials. Therein, the primary portion of the brake disc is comprised of a conventional and economical cast iron material and only a small part of the brake disc, limited to a friction ring, is comprised of a high value and expensive corrosion resistant friction material. The inventive brake disc is thus comprised of a cast iron carrier disc and a friction ring. The cast iron carrier disc is comparable to a conventional cast iron brake disc. In particular with respect to the quality of the material and the corrosion resistance of the cast iron brake disc, reference can be made to existing technology.

### BRIEF DESCRIPTION OF THE DRAWINGS

For further explanation of the invention, reference is made to the schematic drawings. There as shown in:

FIG. 1 a bake disc with cast iron carrier disc 1, friction disks 2, cooling channels 3, rips or struts 4, projections 5,. recesses 6 and side borders 7, and

FIG. 2 a brake disc with cast iron carrier disc 1 friction rings 2 cooling channels 3 and rips or struts 4.

### DETAILED DESCRIPTION OF THE INVENTION

While the carrier disc is constructed of conventional materials, the friction ring is comprised of a high value friction material which exhibits a sufficient corrosion stability even under continuous friction loading.

In the selection of the friction ring material care should be taken that this is chemically and physically compatible with the cast iron material of the carrier ring. This means that the thermal mechanical characteristics, in particular the thermal coefficient of expansion, exhibits similar values, as well as that no undesired electrical chemical contact corrosion can occur.

The inventive brake disc has the advantage, that the economical and proven cast iron materials can continue to be used for the primary portion of the brake disc. Since only a small part of the conventional brake disk is replaced by a friction ring, the conventional brake discs already installed in series production automobiles can be replaced by the inventive brake discs without special adaptive means. The high value material of the friction ring has only a small impact on the cost of the brake disc. By maintaining the cast iron carrier ring, the conventional manufacturing processes can in part be maintained. For the friction ring, the most diverse friction materials can in principal be employed.

In a first inventive embodiment the intermetallic composites (IMC), ceramic-matrix-composite materials (CMC), Metal-Metal-Composites (MMC) or fiber re-enforced ceramics (FRC) can be employed as materials for the friction ring. In these composite materials, particular consideration is to be given to suitable chemical and physical compatibilities. This is achieved for example by a high proportion of metallic component in the IMC or MMC composite materials. Among the IMC materials, particularly suited are composites produced on the basis of titanium aluminide and aluminum oxide, which have a good compatability with the cast iron carrier disc.

In a preferred embodiment of the invention the friction ring is comprised of a metallic friction material, and particularly preferred is an iron alloy. Thereby the greatest amount of compatibility is achieved. Besides this, such an alloy is very economical in comparison to IMC, CMC, MMC or FRC.

Particularly preferred is when the friction ring is formed of a highly alloyed cast iron, Ni/resist-cast iron, Ni/Cr-steel or highly alloyed steel.

The preferred iron alloys exhibit a sufficient corrosion resistance with good friction characteristics. In contrast to the conventional cast iron materials, a separate corrosion resistance is not necessary.

The cast iron carrier disc 1 and the friction ring 2 are originally connected with each other. Particularly preferred is when the cast iron carrier disk 1 and the friction ring 2 are metallergically bonded with each other. Therein, a metallic fusion layer or intermetallic layer is located between the two bodies. The fusion layer includes alloy elements of the friction ring material and the cast iron material of the carrier ring. The metallurgic joining processes includes, among other processes, welding, soldering and casting.

In one preferred embodiment one of the two components of the brake disc is cast into the other. Particularly preferred is when the friction ring 2 is cast into the cast iron carrier disc 1. Thereby a material bonding and metallurgical joining is accomplished.

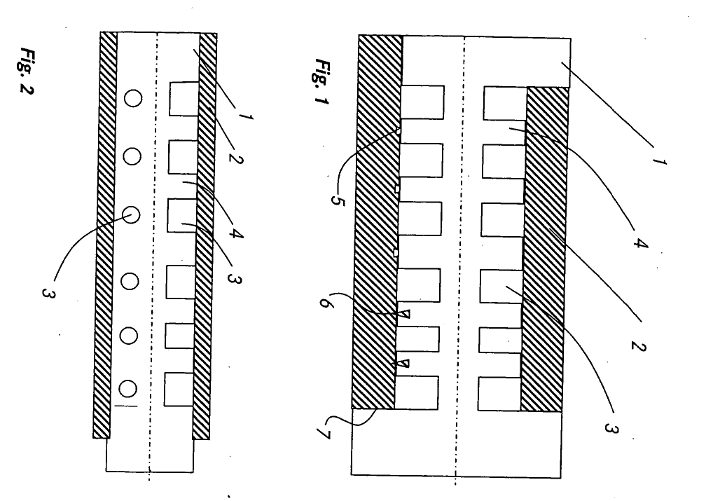

Preferred embodiments of the inventive brake disc are schematically illustrated in FIGS. 1 and 2. The friction ring is, for illustrative purposes, shown thicker than conventional.

FIG. 1 schematically shows an internally ventilated brake disc. Therein the different construction features are shown on the upper and lower sides. The upper side includes a friction ring 2 which is bounded on both sides, or as the case may be on the side surfaces, by the cast iron carrier ring. Towards downwards the friction 2 is in contact with the cross pieces 4 of the carrier ring and forms the upper side of the cooling channels 3 running in the brake disc. The friction ring is introduced into the carrier ring and is held extraordinarily rigidly via the side boundaries. The friction surface is therein not limited to the free running surface of the friction ring, but can, within certain boundaries, extend also over the surface of the adjacent carrier disc.

For the schematic representation of additional preferred constructive characteristics the lower side of the brake disc shown in FIG. 1 is only bordered on one side. Preferably the boundary lies on the side nearest the brake disc pot. The bottom side exhibits projections 5 at the cross bars 4, which bring about a mechanical clamping between the friction ring and carrier disc. Particularly preferred is when the projections 5 exhibit slanted surfaces or cutbacks. A further preferred variant for mechanical engagement includes recesses 6 in the projections 4 which are filled in by material of the friction ring.

It can be useful to protect the surface of the cast iron carrier disc against corrosion using a suitable coating. For this, the known corrosion protective coatings can be employed.

A further aspect of the invention concerns advantageous processes for production of composite brake discs comprising a cast iron carrier disc with at least one friction ring.

In a first preferred embodiment the composite brake disc is formed by joining a cast iron brake disc 1 with at least one friction ring 2 by friction welding of the friction ring 2 to the carrier disc 1. This friction ring is preferably comprised of an iron alloy as described above. The friction welding has, in comparison to other welding processes, the advantage that the two bodies can be joined over large surfaces at internal inaccessible areas. The friction welding can bring about a reliable joining along the entire surface of the carrier disc or only along the cross pieces 4.

For the technique of joining by friction welding, in a preferred embodiment the surfaces of the carrier disc and/or friction disc to be joined are coated with a solder like material. Particularly preferred is a Sn-or Ni-base alloy. The coatings support or reinforce during welding the formation of a very solid and even metallurgic joining layer.

A particularly preferred additional variation of the process is carried out by joining a cast iron carrier disc 1 with at least one friction ring 2 by casting the carrier disc 1 onto the at least one friction ring 2. As a rule, brake discs are produced symmetric with two friction rings. For carrying out the joint casting, the friction rings are provided as inserts in a casting mold. The recesses sometimes present in the carrier disc can be produced in known manner by introducing cores into the cast mold.

In a preferred embodiment, in the production of internally ventilated brake discs, the friction rings are first joined with a casting cores defining the ventilation channels, and then the assembly is introduced or as the case may be fixed in the casting mold. Thereby in particular brake discs can be produced, in which the cast iron carrier disc and the friction ring 2 are joined with each other essentially only via the cross pieces 4, which define the boundaries of the cooling channels 3.

A further variant of the process of composite casting includes the following essential steps:
two friction rings 2 are introduced into the casting mold opposite to each other and spaced apart by casting cores,
the carrier disc 1 is cast into the casting mold, and
following casting, the casting cores are removed. Thereby the voids in the casting core become cooling channels 3 in the carrier discs. The friction ring 2 and the carrier disc 1 are metallurgically bonded with each other during the casting. The formed cooling channels are at least partially bordered on one of their sides by the material of the friction ring.

In accordance with a further process variation, first the carrier disc is produced in particular by known casting techniques and the one or two friction rings are cast onto the carrier disc.

In composite casting it is of advantage to coat the joining surface of the carrier disc or friction disc, depending upon which of the components is not being cast on, with a solder-like material prior to joining. For coating, there is suited in particular a thermal spray coating of Sn-, or Ni-alloys.

In comparison to friction welding, composite casting has the advantage that the carrier disc or the friction disc can exhibit, prior to casting, projections 5 and/or recesses 6 in the at least one joining surface, which following casting can bring about a retention of the friction disc. The recesses can be introduced in microscopic dimensions, for example by sandblasting or high pressured water jetting. In the same way macroscopic recesses or projections can be formed in simple manner using suitable casting molds during casting of the component. The macroscopic dimensions lie in the millimeter range, in particular in the range of 0.5 to 5 mm.

1-12. (canceled)

13. A high gloss hollow article comprising a wall structure having an external surface and an internal surface defining an internal chamber having a diameter of from about 0.5 mm to about 250 mm, said wall structure comprising at least one layer formed essentially of a metallocene produced polyethylene resin and having all external surface having a gloss of at least 40 as determined by the standard test of ASTM D2457-90.

14. An article according to claim 13, wherein the metallocene-produced polyethylene has a density of from 0.910 g/cm³ up to 0.966 g/cm³, and a melt index, M12, of from 0.001 to 20 g/10 min.

15. An article according to claim 13, wherein the metallocene-produced polyethylene has a density of 0.915 g/cm³ to 0.940 g/cm³ and a melt index, M12, of from 0.5 g/10 min. to 2.5 g/10 min.

16. An article according to claim 13 wherein the metallocene-produced polyethylene has a molecular weight distribution of from 2 to 7.

17. An article according to claim 13 wherein said wall structure is formed of a single layer.

18. An article according to claim 13 wherein said wall structure comprises a second disposed internal surface of said at least one layer.
